(19) United States
(12) Patent Application Publication
(10) Pub. No.: US 2010/0332673 A1
(43) Pub. Date: Dec. 30, 2010

(54) METHOD AND APPARATUS OF REFERRING TO STREAM INCLUDED IN OTHER SAF SESSION FOR LASER SERVICE AND APPARATUS FOR PROVIDING LASER SERVICE

(76) Inventors: Ye-Sun Joung, Daejeon-city (KR); Won-Sik Cheong, Daejeon-city (KR); Jihun Cha, Daejeon-city (KR); Kyung-Ae Moom, Daejeon-city (KR); Young-Kwon Lim, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/446,077

(22) PCT Filed: Oct. 17, 2007
(86) PCT No.: PCT/KR2007/005089

§ 371 Date: Apr. 17, 2009

(30) Foreign Application Priority Data
Oct. 17, 2006 (KR) 10-2006-0101040
Jul. 13, 2007 (KR) 10-2007-0070797

(51) Int. Cl. G06F 15/16

(52) U.S. Cl. 709/231

(57) ABSTRACT

Provided are a method and apparatus for enabling a main stream to refer to an elementary stream existing in another simple aggregation format (SAF) session by using a global ID during provision of a light application scene representation (LASeR) service, and a LASeR service providing apparatus. In order for a main stream to refer to an elementary stream included in an SAF session different from an SAF session in which the main stream is included without a change of existing LASeR and SAF stream structures, the main stream for a LASeR service uses a global stream ID of the elementary stream as a reference value. Accordingly, the elementary stream included in the SAF session different from the SAF session of the main stream can be effectively referred to without need to create a separate apparatus or change an existing apparatus even when a global ID included in a LASeR scene description is used as in the conventional art.

### BACKGROUND OF THE INVENTION

1. Field of the Invention

The present invention relates to reference of elementary streams existing in other Simple Aggregation Format (SAF) sessions by using global IDs, and more particularly, to a method and apparatus for enabling a main stream for light application scene representation (LASeR) service to refer to elementary streams existing in other SAF sessions by using, as a reference value, a global stream ID existing in a LASeR scene description when a LASeR service is provided.

2. Description of the Related Art

A multi-media contents scene description standard proposed in a current MPEG-4 system standard document, namely, in ISO/IEC 14496-1, is a Binary Format for Scenes (BIFS). The BIFS written in ISO/IEC 14496-1 includes an enormous amount of contents—almost 200 pages. Accordingly, the BIFS is considered not appropriate for environments which have a lack of usable resources, such as mobile phones. This has lead to the development of a new standard which is light application scene representation (LASeR).

In other words, LASeR can be considered for use as a format of multi-media contents created so that terminals which have a lack of resources such as mobile phones can provide simple multi-media services. In particular, a MPEG-4 LASeR standard uses a text and report action streaming method that has been standardized in 3GPP Release 6. The format of a packet in this streaming method is defined as a Simple Aggregation Format (SAF). The SAF may be expressed in a text format (XML) or a currently proposed binary format BiM.

However, a current SAF standard includes no method of handing the case in which streams to which LASeR and SAF streams desire to refer exist in other SAF sessions. In other words, a main stream cannot refer to streams located in other SAF sessions.

### SUMMARY OF THE INVENTION

The present invention provides a method and apparatus for referring to an elementary stream received from another server and included in another Simple Aggregation Format (SAF) session without a change of existing light application scene representation (LASeR) and SAF structures by using a global stream ID included in a LASeR scene description, and a service providing apparatus based on the above-described stream reference.

According to an aspect of the present invention, there is provided a method of referring to a stream existing in another simple aggregation format (SAF) session in a light application scene representation (LASeR) service, the method comprising: determining an elementary stream to which a stream located in a first SAF session desires to refer, being located in a second SAF session different from the first SAF session; identifying a global stream ID on a LASeR service scene description regarding the determined elementary stream; and storing the identified global stream ID as a reference value of the stream located in the first SAF session.

According to another aspect of the present invention, there is provided an apparatus for referring to a stream existing in another simple aggregation format (SAF) session in a light application scene representation (LASeR) service, the apparatus comprising: a reference determining unit determining an elementary stream to which a stream located in a first SAF session desires to refer, the elementary stream being located in a second SAF session different from the first SAF session; a stream ID identifying unit identifying a global stream ID on a LASeR service scene description about the determined elementary stream; and a reference storage unit storing the identified global stream ID as a reference value of the stream located in the first SAF session.

According to another aspect of the present invention, there is provided a LASeR service providing apparatus providing a LASeR service based on reference to streams included in other SAF sessions, the apparatus comprising: a stream ID identifying unit identifying a global stream ID of an elementary stream to be referred to from reference values in a LASeR scene description stream; a reference information acquiring unit acquiring information about the elementary stream to be referred to by using the identified global stream ID from a global stream ID table; and a service providing unit providing a LASeR service by referring to the elementary stream on the basis of the acquired information.

In a method and apparatus for enabling a LASeR service to refer to a stream included in another SAF session and a LASeR service providing apparatus according to the present invention, a main stream can efficiently refer to an elementary stream received from another server and included in another SAF session without a change of existing LASeR and SAF structures by using a global stream ID included in an existing LASeR scene description.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates reference of an elementary stream located in another Simple Aggregation Format (SAF) session by using a global stream ID, according to an embodiment of the present invention;

FIG. 2 is a flowchart of a method of enabling a LASeR scene description stream to refer to a stream existing in another SAF session by using a global stream ID, according to an embodiment of the present invention;

FIG. 3 is a block diagram of an apparatus for enabling a LASeR scene description stream to refer to a stream existing in another SAF session by using a global stream ID, according to an embodiment of the present invention;

FIG. 4 is a block diagram of a LASeR service providing apparatus based on reference of streams existing in other SAF sessions, according to an embodiment of the present invention; and

FIG. 5 is a block diagram illustrating a detailed structure of the LASeR service providing apparatus shown in FIG. 4, according to an embodiment of the present invention.

### DETAILED DESCRIPTION OF THE INVENTION

The present invention will now be described more fully with reference to the accompanying drawings, in which exemplary embodiments of the invention are shown.

A method of referring to an elementary stream to which a stream located in a Simple Aggregation Format (SAF) session desires to refer to, the elementary stream being located in another SAF session, according to the present invention, will become more apparent by describing in detail exemplary embodiments thereof with reference to the attached drawings.

The term “light application scene representation (LASeR)” used in the present specification directly indicates standard technology described in MPEG-4 Part 20. However, LASeR according to the present invention is a method in which terminals which have a lack of resources, such as mobile phones, represent scenes of multimedia contents in order to provide rich media services. The LASeR according to the present invention is applicable to applications, such as maps, animations, and two-dimensional vector graphics, in mobile phones. Accordingly, hereinafter, the term “LASeR” needs to be understood as not only the technology described in MPEG-4 Part 20 but also a technique for general scene description or scene representation, which terminals which have a lack of resources, such as mobile phones, require in order to provide rich media services.

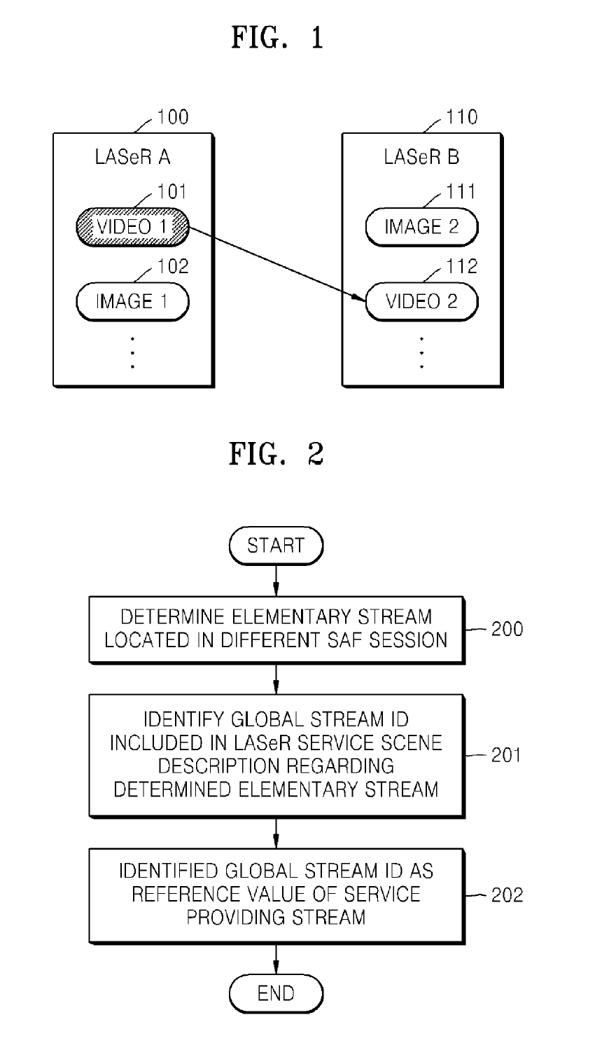

FIG. 1 illustrates reference of an elementary stream located in another Simple Aggregation Format (SAF) session by using a global stream ID, according to an embodiment of the present invention.

When a light application scene representation (LASeR) service A desires to refer to a video elementary stream that is used in a LASeR service B, a LASeR scene description A that represents a structure of the LASeR service A points to a video node on a LASeR scene description B that represents a structure of the LASeR service B. This pointing corresponds to reference of the elementary stream.

A LASeR service denotes rich media contents manufactured by using a LASeR standard. The rich media contents include a variety of video contents, audio contents, graphic contents, and user interaction contents.

The rich media contents also use a variety of media, and thus need a script regarding how to arrange the media on a screen, what time the media are to be synchronized, and which one of the user interactions is to be accepted. This script can be a LASeR scene description. The SAF session denotes a group of logic elementary streams.

Referring to FIG. 1 on the basis of the above description, in order for a video node 101 of a LASeR service A 100 to refer to a video node 112 of a LASeR service B 110, the value of an attribute of an href field included in the video node 101 of the LASeR service A 100 should include an ID of the LASeR service B 110 and a global stream ID of the video node 112 that is to be referred to.

The LASeR service A 100 may be a main stream, and the video node 112 of the LASeR service B 110, which represents video 2 and is an SAF session other than an SAF session corresponding to the LASeR service A 100, may be named with a global ID. In this case, an href field indicating the location of an actual video stream exists in the video node 101 of the LASeR service A 100, representing video 1. The href field has a value set as <video id=“Video 1” href=“LASeR service B ID/global ID of video 2”/>.

Then, during a subsequent interpretation of information about the video node 101, a relation between IDs indicated by the href field is interpreted using a global ID table. Thus, the video node 101 can utilize the media used in the video node 112.

In other words, node reference can correspond to reference of the location of a corresponding medium instead of reference of a certain format of a stream.

The node reference is not limited to video nodes but may be applied to other elementary nodes such as image nodes 102 and 112.

FIG. 2 is a flowchart of a method of enabling a LASeR scene description stream to refer to a stream existing in another SAF session by using a global stream ID, according to an embodiment of the present invention.

Referring to FIG. 2, in operation 200, an elementary stream to which a stream located in a first SAF session desires to refer is determined, the elementary stream being located in a second SAF session different from the first SAF session. In operation 201, a global stream ID included in a LASeR service scene description regarding the determined elementary stream is identified. Thereafter, in operation 202, the identified global stream ID is stored as a reference value to be used by the stream located in the first SAF session.

The stream located in the first SAF session denotes a main stream for a LASeR service or an elementary stream included in the main stream. The elementary stream located in the second SAF session denotes an elementary stream for a separate LASeR service.

The global stream ID includes an ID of the elementary stream of the separate LASeR service located in the second SAF session.

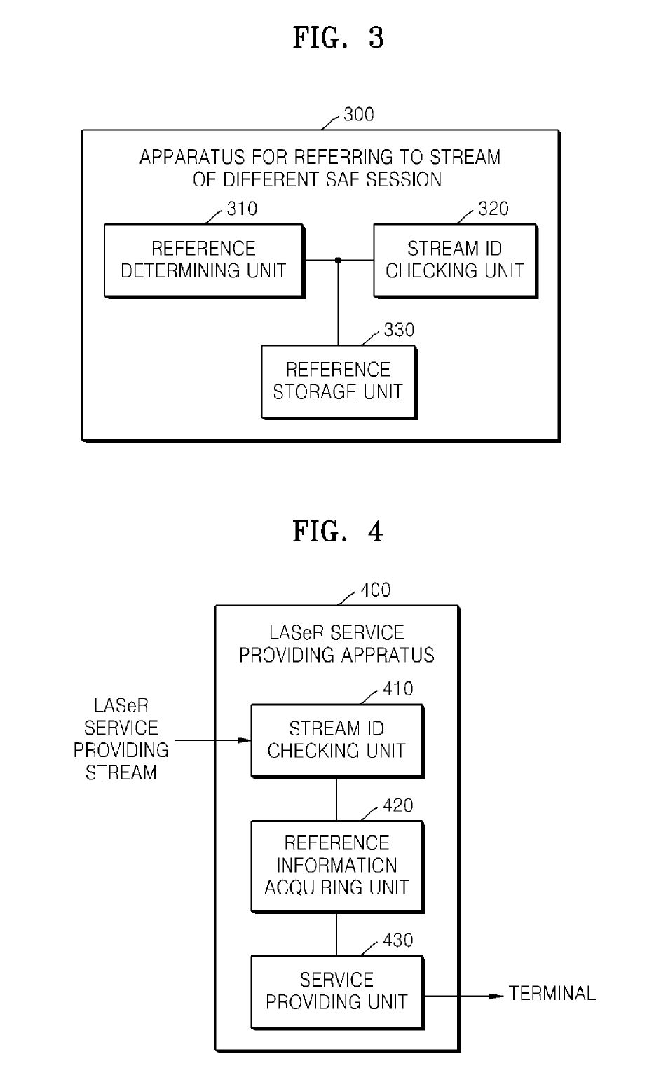

FIG. 3 is a block diagram of an apparatus 300 for enabling a LASeR scene description stream to refer to a stream existing in another SAF session by using a global stream ID, according to an embodiment of the present invention.

Referring to FIG. 3, the apparatus 300 includes a reference determining unit 310, a stream ID identifying unit 320, and a reference storage unit 330. The reference determining unit 310 determines an elementary stream to which a stream located in a first SAF session desires to refer, the elementary stream being located in a second SAF session different from the first SAF session. The stream ID identifying unit 320 identifies a global stream ID included in a LASeR service scene description regarding the determined elementary stream. The reference storage unit 330 stores the identified global stream ID as a reference value to be used by the stream located in the first SAF session. The global stream ID includes an ID of the elementary stream of a separate LASeR service located in the second SAF session.

FIG. 4 is a block diagram of a LASeR service providing apparatus 400 based on reference of streams existing in other SAF sessions, according to an embodiment of the present invention.

The LASeR service providing apparatus 400 provides a LASeR service by enabling a LASeR scene description stream to refer to an elementary stream existing in another SAF session by using a global stream ID of the elementary stream as a reference value. The global stream ID is included in the LASeR scene description stream.

Referring to FIG. 4, the LASeR service providing apparatus 400 includes a stream ID identifying unit 410, a reference information acquiring unit 420, and a service providing unit 430. The stream ID identifying unit 410 identifies the global stream ID of the elementary stream to be referred to from reference values in the LASeR scene description stream. The reference information acquiring unit 420 acquires information about the elementary stream to be referred to by using a global stream ID table on the basis of the identified global stream ID. The service providing unit 430 provides a LASeR service by referring to the elementary stream on the basis of the acquired information.

The elementary stream to be referred to is set as an elementary stream located in an SAF session different from an SAF session corresponding to the LASeR scene description stream. The global stream ID is set to include an ID of the elementary stream of a separate LASeR service to be referred to.

The global stream ID table includes IDs of global streams (e.g., local streamldForThisGlobal), titles thereof (e.g., globalName), and lengths thereof (e.g., globalNameLength).

The service providing apparatus 400 may further include an ID processing unit for analyzing and processing a service ID and the global stream ID from reference values of the LASeR scene description stream.

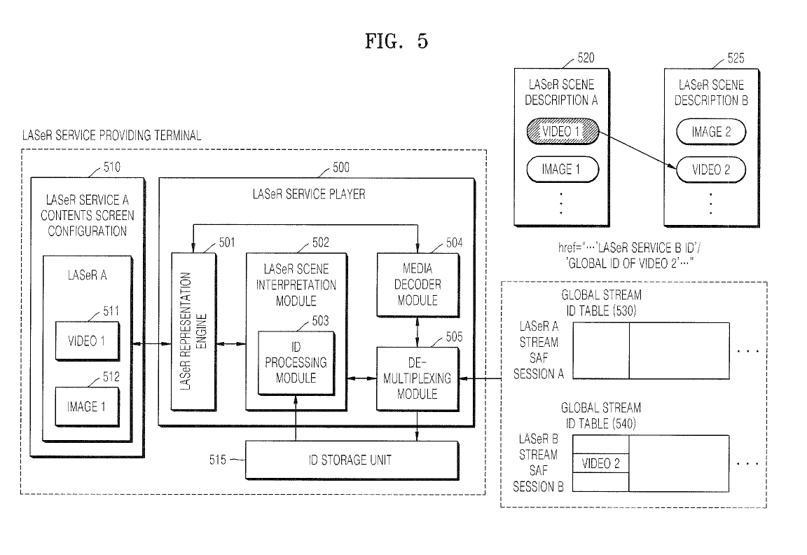

FIG. 5 is a block diagram illustrating a detailed structure of the LASeR service providing apparatus 400 shown in FIG. 4, according to an embodiment of the present invention.

The LASeR service providing apparatus shown in FIG. 5 corresponds to the LASeR service providing apparatus 400 of FIG. 4 when a LASeR B stream 525 on a LASeR scene description A 520 is referred to while a LASeR service A is being provided to a LASeR service providing terminal 510.

Referring to FIG. 5, a LASeR service player 500 includes a LASeR scene interpretation module 502 and a demultiplexing module 505. The LASeR scene interpretation module 502 analyses and processes a service ID and a global stream ID. In order to refer to an elementary stream or a resource included in another SAF session according to the result of the analysis, the demultiplexing module 505 identifies the stream using a global stream ID table 540 on the basis of the global stream ID which is a reference value.

The LASeR scene interpretation module 502 includes an ID processing module 503 in order to analyze a LASeR scene description, to thereby control a LASeR representation engine 501 to show the analyzed scene to the LASeR service providing terminal 510. The scene provided by the LASeR representation engine 501 is displayed as a video 511 and an image 512 on the LASeR service providing terminal 510. The LASeR service player 500 further includes a media decoder module 504 for performing decoding. The ID processing module 503 includes an ID storage unit 515 in order to store distinguished IDs.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of referring to a stream existing in another simple aggregation format (SAF) session in a light application scene representation (LASeR) service, the method comprising:
determining an elementary stream to which a stream located in a first SAF session desires to refer, being located in a second SAF session different from the first SAF session;
identifying a global stream ID on a LASeR service scene description regarding the determined elementary stream; and
storing the identified global stream ID as a reference value of the stream located in the first SAF session.

2. The method of claim 1, wherein the stream located in the first SAF session is one of a main stream for a LASeR service and an elementary stream included in the main stream.

3. The method of claim 1, wherein the elementary stream located in the second SAF session is an elementary stream for a separate LASeR service.

4. The method of claim 3, wherein the global stream ID comprises an ID of the elementary stream of the separate LASeR service located in the second SAF session.

5. A computer readable recording medium having recorded thereon a computer program for the method of one of claims 1 through 4.

6. An apparatus for referring to a stream existing in another simple aggregation format (SAF) session in a light application scene representation (LASeR) service, the apparatus comprising:
a reference determining unit determining an elementary stream to which a stream located in a first SAF session desires to refer, the elementary stream being located in a second SAF session different from the first SAF session;
a stream ID identifying unit identifying a global stream ID on a LASeR service scene description about the determined elementary stream; and
a reference storage unit storing the identified global stream ID as a reference value of the stream located in the first SAF session.

7. The apparatus of claim 6, wherein the global stream ID comprises an ID of the elementary stream of the separate LASeR service located in the second SAF session.

8. A LASeR service providing apparatus providing a LASeR service based on reference to streams included in other SAF sessions, the apparatus comprising:
a stream ID identifying unit identifying a global stream ID of an elementary stream to be referred to from reference values in a LASeR scene description stream;
a reference information acquiring unit acquiring information about the elementary stream to be referred to by using the identified global stream ID from a global stream ID table; and
a service providing unit providing a LASeR service by referring to the elementary stream on the basis of the acquired information.

9. The LASeR service providing apparatus of claim 8, wherein the elementary stream to be referred to is located in an SAF session different from an SAF session where the LASeR scene description stream is included.

10. The LASeR service providing apparatus of claim 8, wherein the global stream ID comprises an ID of the elementary stream of a separate LASeR service included in the SAF session different from the SAF session where the LASeR scene description stream is included.

11. The LASeR service providing apparatus of claim 8, wherein the global stream ID table comprises IDs of global streams, titles of the global streams, and lengths of the global streams.

12. The LASeR service providing apparatus of claim 8, further comprising an ID processing unit analyzing and processing a service ID and the global stream ID from reference values of the LASeR scene description stream.

13. A method of providing a scene representation service based on reference to streams included in other SAF sessions, the method comprising:
identifying a global stream ID of an elementary stream to which a stream located in a first SAF session desires to refer to, the elementary stream being located in a second SAF session different from the first SAF session, from reference values in a scene description service providing stream;
acquiring information about the elementary stream by using the identified global stream ID from a global stream ID table; and
providing a scene representation service by referring to the elementary stream on the basis of the acquired information.

14. The method of claim 13, wherein the global stream ID comprises an ID of the elementary stream of the separate scene representation service located in the second SAF session.

15. The method of claim 13, wherein the global stream ID table comprises IDs of global streams, titles of the global streams, and lengths of the global streams.
